(19) United States
(12) Patent Application Publication
(10) Pub. No.: US 2015/0227994 A1
(43) Pub. Date: Aug. 13, 2015

(54) NETWORK RECURSIVE GROWTH PROCESSES AND SYSTEM

(71) Applicants: Leeam Dagan, North Hollywood, CA (US); Simon Nicolai Heit, North Hollywood, CA (US)

(72) Inventors: Leeam Dagan, North Hollywood, CA (US); Simon Nicolai Heit, North Hollywood, CA (US)

(21) Appl. No.: 14/617,841

(22) Filed: Feb. 9, 2015

Related U.S. Application Data
(60) Provisional application No. 61/937,279, filed on Feb. 7, 2014.

(51) Int. Cl. G06Q 30/06; G06Q 50/00; G06Q 30/02

(52) U.S. Cl. CPC G06Q 30/0605; G06Q 30/0277; G06Q 50/01

(57) ABSTRACT

A social media network marketplace model with mass recursive growth is disclosed. The social media network marketplace model includes a network recursive growth system and a set of network recursive growth processes for non-direct purchasing of advertising on massive targeted pages of networked websites. The massive targeted pages of networked websites include media pages on social media networking websites and other such high traffic pages.

### CLAIM OF BENEFIT TO PRIOR APPLICATION

This application claims benefit to U.S. Provisional Patent Application 61/937,279, entitled “Social media network marketplace model enabling mass recursive growth,” filed Feb. 7, 2014. The U.S. Provisional Patent Application 61/937,279 is incorporated herein by reference.

### BACKGROUND

Embodiments of the invention described in this specification relate generally to advertising purchasing systems on massive targeted web pages.

Mass media pages on social media networking sites are difficult to contact for advertising purposes. While direct contact with an individual can be made and occasionally there is contact information provided at a site, this manner of contacting severely limits those interested in large scale advertising. The crux of the problem is that, beyond direct contact, there is no readily available way to purchase advertising on massive targeted pages.

For instance, there are many advertisers who advertise directly to target customers who are interested in certain products, such that each item may be purchased on a huge scale to customers who are interested in the content, as well as potential customers who may become buying customers if offered additional information (e.g., by delivery of a link directly to a network). Each purchase is redelivering the link to this many people, while each additional vendor added to the page brings another massive influx of new target customers to add to the pool.

Therefore, what is needed is a way to purchase advertising, beyond using a direct contact, on massive targeted pages, such as media pages on social media networking sites, and generate massive amounts of targeted traffic, by its recursive structure.

### BRIEF DESCRIPTION

Some embodiments of the invention include a novel network recursive growth system and a set of network recursive growth processes for non-direct purchasing of advertising on massive targeted pages of networked websites. The massive targeted pages of networked websites include media pages on social media networking websites and other such high traffic pages.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a sell-vendor platform view of a network recursive growth system in some embodiments.

FIG. 2 conceptually illustrates a link-back catalyst platform between buyer and seller in a network recursive growth system in some embodiments.

FIG. 3 conceptually illustrates a buy digital space on a social media platform view of a network recursive growth system in some embodiments.

FIG. 4 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel network recursive growth system and a set of network recursive growth processes for non-direct purchasing of advertising on massive targeted pages of networked websites. The massive targeted pages of networked websites include media pages on social media networking websites and other such high traffic pages.

As stated above, mass media pages on social media networking sites are difficult to contact for advertising purposes. Embodiments of the invention described in this specification solve such problems with a network recursive growth process and system that allows thousands of highly targeted customers to purchase direct advertising on their favorite pages. The continual addition of pages in the same genre is constantly benefiting both the customer and vendor, by increasing in both choice and reach. As the choices increase, the customer base increases, and as the customer base increases, the individual pages grow. As a result, the customer base again increases, new pages are found, etc. This recursive loop is endless and lies at the heart of the network recursive growth processes and system. Every purchase and every new page must link back to the homepage, consistently providing an incredible influx of known targeted customers.

The embodiments described in this specification differ from and improve upon currently existing options. In particular, some embodiments differ because this is the first model that allows a customer to purchase from any of several selectable social media pages. In addition, these embodiments improve upon the currently existing options by the recursive nature of this model.

Users of some sales sites on the web sell items one at a time by conducting, for example, a single auction every week. This is slow, inefficient, and unmarketed. In contrast, the network recursive growth system and a set of network recursive growth processes advertise directly to the customers that are interested in the products, and each item purchased is delivered to countless other people who are interested in the content, in addition to vast numbers of potential customers who are provided a link directly to the network. Thus, each purchase is redelivering the link to very many people, and each additional vendor added to the page brings an influx of many more new targeted customers to add to the pool.

The network recursive growth system of the present disclosure may be comprised of the following elements. This list of possible constituent elements is intended to be exemplary only and it is not intended that this list be used to limit the network recursive growth system of the present application to just these elements. Persons having ordinary skill in the art relevant to the present disclosure may understand there to be equivalent elements that may be substituted within the present disclosure without changing the essential function or operation of the network recursive growth system.

1. Online Marketplace for content sharing on social media pages

2. Recursive linking

3. Open Vendor Format

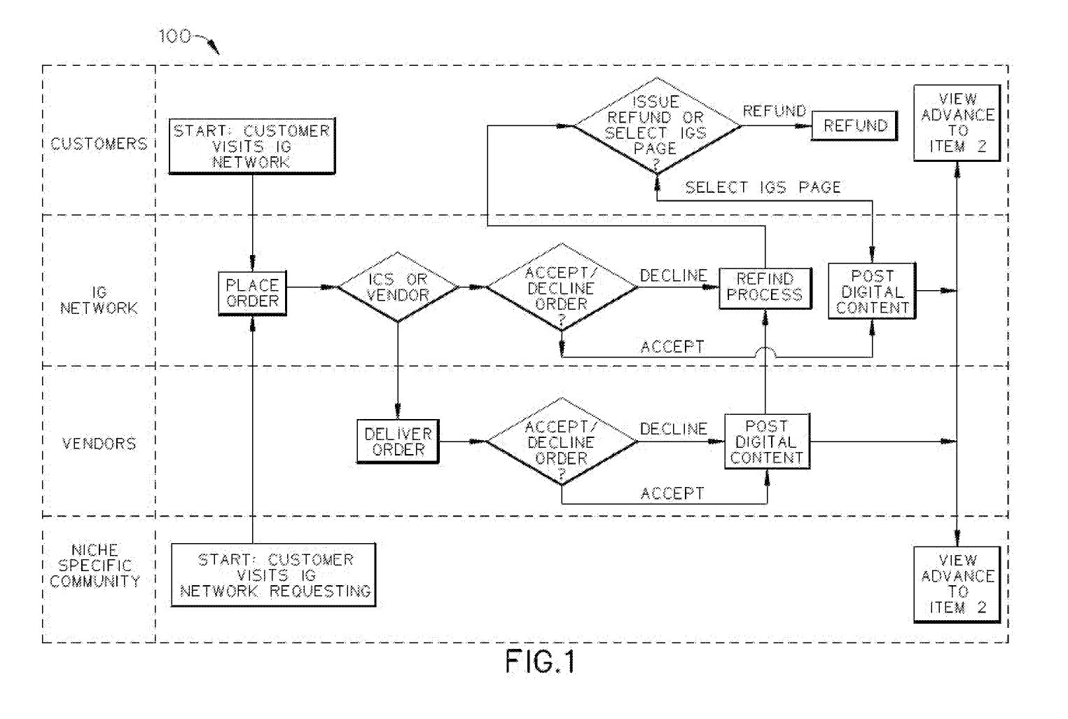

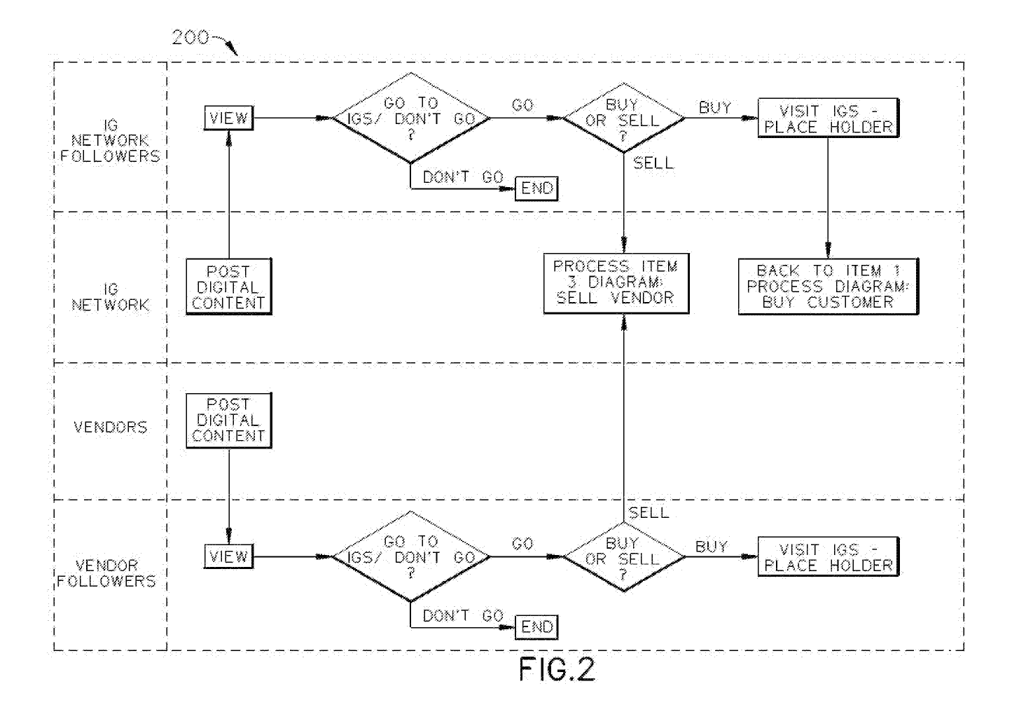

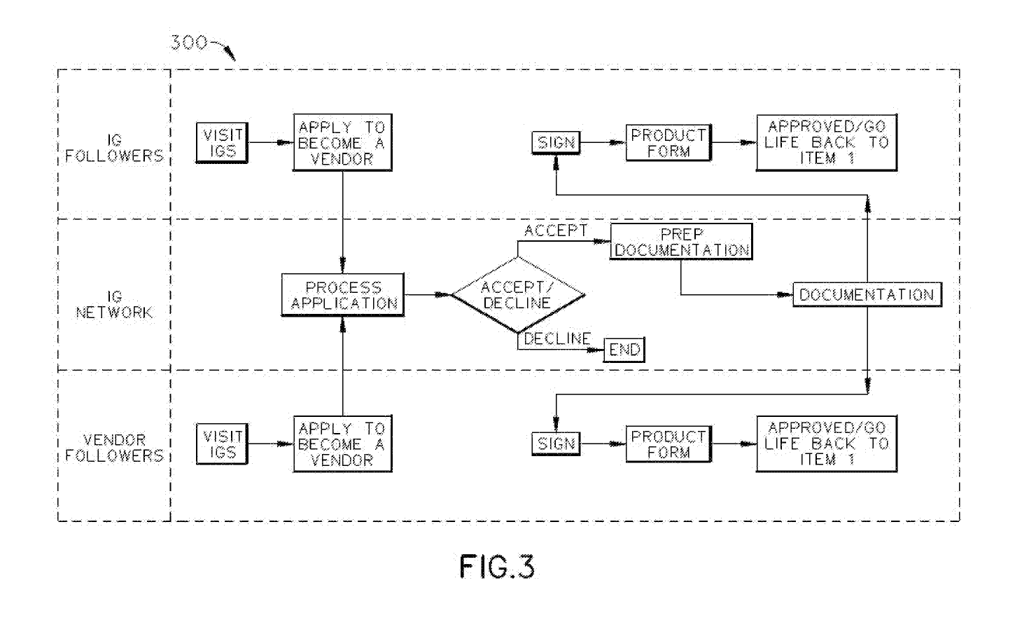

By way of example, FIG. 1 conceptually illustrates a sell-vendor platform 100 view of a network recursive growth system, while FIG. 2 conceptually illustrates a link-back catalyst platform 200 between buyer and seller in the network recursive growth system, and FIG. 3 conceptually illustrates a buy digital space on a social media platform 300 view of the network recursive growth system in some embodiments. As shown in these figures, the network recursive growth system 100-300 generally works because it provides the ability to purchase advertising from massive social media pages in one specific genre such as ‘fitness’ efficiently, securely, with a guarantee of delivery, which has, to date, not been available until now. This enables any page, with a decent following in the field, to join the network. Orders are taken directly by the online marketplace for content sharing on social media pages (i.e., Item 1, above, and as exemplified by the buy digital space on a social media platform 300 shown in FIG. 3) and a percentage is kept. The order is then completed by members of the open vendor format (i.e., Item 3, above, and as exemplified by the sell-vendor platform 100 shown in FIG. 1), and the recursive linking (i.e., Item 2, above, and as exemplified by the link-back catalyst platform 200 shown in FIG. 2) in which the order plus link-back are displayed to all of the targeted ‘followers’ of the particular member of the open vendor format (i.e., Item 3, above, and as exemplified by the sell-vendor platform 100 shown in FIG. 1).

Additionally, the open vendor format (i.e., Item 3, above, and as exemplified by the sell-vendor platform 100 shown in FIG. 1) allows anyone to join, bringing more targeted people and a more targeted audience. Orders are forwarded on to vendors that have joined the online marketplace for content sharing on social media pages (i.e., Item 1, above, and as exemplified by the buy digital space on a social media platform 300 shown in FIG. 3) and the vendors must link back to the network (i.e., the recursive linking element of Item 2, above, and as exemplified by the link-back catalyst platform 200 shown in FIG. 2).

In summary, the network recursive growth system protects the concept of an online marketplace for a selection of social media pages, that sells advertising space, and/or time on their page to display customers content.

The link-back model is described by the sales of content that is being delivered back to targeted potential customers, with a link back to the main network/marketplace.

The open vendor model that allows anyone with enough followers in the appropriate genre to join the network for a service fee by order. There is 3 core parts of our business model that should protected against use any combination of said 3 items.

A first core part of the network recursive growth system includes the online marketplace for content sharing on social media pages (i.e., Item 1, above, and as exemplified by the buy digital space on a social media platform 300 shown in FIG. 3). In some embodiments of the network recursive growth system, the online marketplace includes a network/marketplace/online store that contains multiple social media pages with similar genres/interests/follower base/targeted customers and grants the ability of a follower to purchase advertising or time/space on the page and display their own digital content (including but not limited to: image(s), text, video(s), link back(s) to personal page(s), URL web link(s), email, contact info, etc.).

Another core part of the network recursive growth system includes the recursive linking element (i.e., Item 2, above, and as exemplified by the link-back catalyst platform 200 shown in FIG. 2) which includes a business model that sells content that is redelivered to its own following and recursively advertises as it delivers orders.

Yet another core feature of the network recursive growth system includes the open vendor format (i.e., Item 3, above, and as exemplified by the sell-vendor platform 100 shown in FIG. 1) to formulate a marketplace and protect the marketplace from having an open vendor policy that allows any social media page in a related genre to join and sell content sharing time/space. The open vendor policy in related genres gives any vendor who joins instant access to millions of targeted customers as well as adding its own and growing the main network.

To make or use the network recursive growth system of the present disclosure, a person would start by creating a marketplace/network/online store that advertised the concept of buying time/space for digital content on a social media page of a particular genre. The person would then contact as many pages as possible in the genre with the highest number to join your network and begin to sell orders to each other's followers and targeted potential customers. Having the vendors sign an agreement to link back to the main network would increase the growth of the network consistently.

In some embodiments, the network recursive growth system incorporates direct communication between seller and vendor, including a feedback system and order completion confirmation by both the customer and vendor.

In some embodiments, the network recursive growth system includes an automated vendor sign-up process that renders the system highly efficient. In some embodiments, the network recursive growth system fully integrates a verified digital signature company for signing of documents (NDP, vendor agreement) and only requires human approval to grant a vendor full access to start selling.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. For example, the business model could be used for any business that perpetuates its own sales by selling digital space on its own page. Thus, one of ordinary skill in the art would understand that the invention is not to be limited by the foregoing illustrative details, but rather is to be defined by the appended claims.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

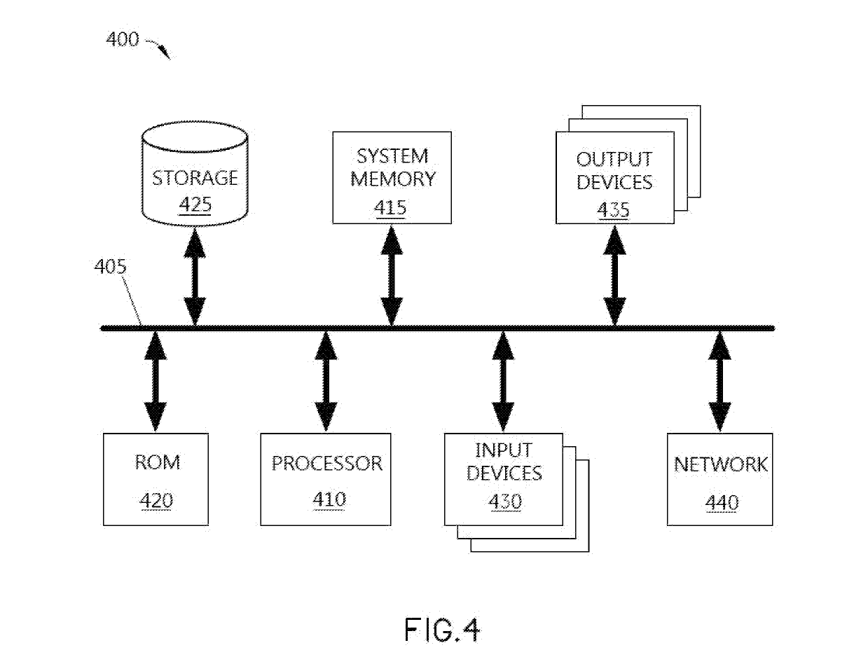

FIG. 4 conceptually illustrates an electronic system 400 with which some embodiments of the invention are implemented. The electronic system 400 may be a computer, phone, PDA, or any other sort of electronic device. Such an electronic system includes various types of computer readable media and interfaces for various other types of computer readable media. Electronic system 400 includes a bus 405, processing unit(s) 410, a system memory 415, a read-only 420, a permanent storage device 425, input devices 430, output devices 435, and a network 440.

The bus 405 collectively represents all system, peripheral, and chipset buses that communicatively connect the numerous internal devices of the electronic system 400. For instance, the bus 405 communicatively connects the processing unit(s) 410 with the read-only 420, the system memory 415, and the permanent storage device 425.

From these various memory units, the processing unit(s) 410 retrieves instructions to execute and data to process in order to execute the processes of the invention. The processing unit(s) may be a single processor or a multi-core processor in different embodiments.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some embodiments of the invention use a mass-storage device (such as a magnetic or optical disk and its corresponding disk drive) as the permanent storage device 425.

Other embodiments use a removable storage device (such as a floppy disk or a flash drive) as the permanent storage device 425. Like the permanent storage device 425, the system memory 415 is a read-and-write memory device. However, unlike storage device 425, the system memory 415 is a volatile read-and-write memory, such as a random access memory. The system memory 415 stores some of the instructions and data that the processor needs at runtime. In some embodiments, the invention's processes are stored in the system memory 415, the permanent storage device 425, and/or the read-only 420. For example, the various memory units include instructions for processing appearance alterations of displayable characters in accordance with some embodiments. From these various memory units, the processing unit(s) 410 retrieves instructions to execute and data to process in order to execute the processes of some embodiments.

The bus 405 also connects to the input and output devices 430 and 435. The input devices enable the user to communicate information and select commands to the electronic system. The input devices 430 include alphanumeric keyboards and pointing devices (also called “cursor control devices”). The output devices 435 display images generated by the electronic system 400. The output devices 435 include printers and display devices, such as cathode ray tubes (CRT) or liquid crystal displays (LCD). Some embodiments include devices such as a touchscreen that functions as both input and output devices.

Finally, as shown in FIG. 4, bus 405 also couples electronic system 400 to a network 440 through a network adapter (not shown). In this manner, the computer can be a part of a network of computers (such as a local area network (“LAN”), a wide area network (“WAN”), or an intranet), or a network of networks (such as the Internet). Any or all components of electronic system 400 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1-3 conceptually illustrates processes. The specific operations of these processes may not be performed in the exact order shown and described. Specific operations may not be performed in one continuous series of operations, and different specific operations may be performed in different embodiments. Furthermore, each process could be implemented using several sub-processes, or as part of a larger macro process. Thus, one of ordinary skill in the art would understand that the invention is not to be limited by the foregoing illustrative details, but rather is to be defined by the appended claims.

I claim:

1. A network recursive growth system comprising:
an online marketplace for content sharing on social media pages, said online marketplace comprising a set of computing devices that are connected to the Internet through which the content of the social media pages is shared, wherein each computing device in the set of computing devices is associated with a vendor in the online marketplace;
a recursive link management server that is connected to the Internet and manages link-backs to content of the social media pages; and
an open vendor server that is connected to the Internet and allows content sellers to register in the online marketplace as a vendor and that aggregates a set of customers associated with the registered content seller so that the content of each vendor in the set of vendors is available to the set of customers.

2. The network recursive growth system of claim 1 further comprising an open vendor database management server that is connected to the open vendor server, said open vendor database management server comprising a set of registered vendors and the set of aggregated customers associated with each registered vendor.

3. The network recursive growth system of claim 1 further comprising a link-back database management system that is connected to the recursive link server, said link-back database management system comprising a set of Internet addresses that link to content offered on one or more social media pages associated with the set of vendors.

4. The network recursive growth system of claim 1, wherein the online marketplace allows vendors to offer content on massive targeted pages of networked websites.

5. The network recursive growth system of claim 4, wherein the massive targeted pages of networked websites comprises media pages on social media networking websites.
